(19) United States
(12) Patent Application Publication
(10) Pub. No.: US 2014/0267776 A1
(43) Pub. Date: Sep. 18, 2014

(54) TRACKING SYSTEM USING IMAGE RECOGNITION

(71) Applicant: MJK Holding. LLC, Dover, DE (US)

(72) Inventor: Andrew Duthu, North Hills, CA (US)

(73) Assignee: MJK Holding. LLC, Dover, DE (US)

(21) Appl. No.: 14/198,972

(22) Filed: Mar. 6, 2014

Related U.S. Application Data
(60) Provisional application No. 61/791,323, filed on Mar. 15, 2013.

(51) Int. Cl. G01S 3/786; G06Q 10/08

(52) U.S. Cl. CPC G01S 3/7864; G06Q 10/087
USPC 348/169

(57) ABSTRACT

A system and method for tracking an object in a defined area, such as a facility or warehouse. The system includes an imaging device installed in the defined area that provides at least a partial three-dimensional image of the object to a server. A database storing a computer-generated three-dimensional model of the object is in communication with the server. The server compares the three-dimensional image from the imaging device to the three-dimensional model stored in the database to identify the object. The server provides location information of the object to a receiving device by sending an image of the defined area including an indicia indicating the location of the object in the defined area. The system also may include tracking technology that can be used to determine the location of the object.

### CROSS-REFERENCE TO RELATED APPLICATIONS

This application claims the benefit of U.S. provisional patent application No. 61/791,323, filed Mar. 15, 2013, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

It is not unusual for parts, including relatively large parts to be misplaced in a production environment. Misplacing parts or even large pallets may occur when an employee, such as a forklift operator, moves a part or pallet containing a part or assembly to another location in order to access another part or pallet. Over time, a part or pallet can continue to be moved away without being returned to its original location. Such a scenario causes considerable time to be wasted later in attempting to locate the part or pallet. It should be understood that the smaller the part being searched for, the greater the problem in trying to locate the misplaced part.

What is needed is a tracking system that can monitor the location of a part and pinpoint its exact location on a display so that a user can more easily locate the desired part. What also is needed is a tracking system that can identify a part or item and provide a user with information concerning the identified part or item.

### SUMMARY

Briefly, and in general terms, various embodiments are directed to a system for tracking an object in a defined area, such as a warehouse of facility. In one embodiment, the system includes a tracking tag attached to the object and a tracking reader that monitors the location of the tracking tag. The tracking reader is located in the defined area. The tracking technology may include Global Positioning Satellite, Radio Frequency Identification, Near Field Communicator, or the like.

The system also includes an imaging device installed in the defined area, and the imaging device includes a field of view. Multiple imaging devices may be installed. The imaging device may provide at least a partial three-dimensional image of the object. As an example, the imaging device may be a Z-depth camera, and the Z-depth camera can capture and provide a node structure or wireframe structure of the object, along with an image of the object. It also has been contemplated that a stereoscopic camera can be used to capture and provide a node structure or wireframe structure of the object. Further, a stereoscopic camera may be used in combination with a Z-depth camera.

The tracking reader and imaging device are in communication with a server. In one embodiment, the tracking reader provides the server with information concerning the location of the object in relation to the tracking reader and the imaging device provides an image of the object to the server. It has been contemplated that the tracking reader will provide a general location of the object and then the server can then determine which imaging device has the object in its field of view. By receiving images or a live feed from the imaging device that has the object in its field of view, the exact location of the object can be determined as shown in the image of the object. The image of the object may be a live video image or a still image.

In addition, a receiving device having a display is in communication with the server. The server can provide an image of the defined area to the display of the receiving device. The server can then highlight or provide an indicia on the image of the defined area indicating the location of the object in the defined area.

A database storing a computer-generated model of the object may also be included in the tracking system. The system may compare the computer-generated model of the object to the node structure or wireframe structure of the object captured by the imaging device in order to identify the object using image recognition software.

Another embodiment is directed to a system for tracking an object in a defined area that includes an imaging device installed in the defined area. The imaging device has a field of view and provides at least a partial three-dimensional image of the object and an image of the object. The image of the object may be a live video image or a still image. The imaging device may be a Z-depth or similar type of camera. The Z-depth camera may provide a node or wireframe structure of the object along with the image of the object to the server. Furthermore, the Z-depth camera can provide information concerning the distance the object is located away from the Z-depth camera.

A database storing a computer generated three-dimensional model of the object also is included in the system. There is a server in communication with the imaging device and the database of the system. The server compares the three-dimensional image from the imaging device to the three-dimensional model stored in the database to identify the object. The location of the object can also be determined by analysing the location of the imaging device, the field of view of the imaging device, and the distance the object is located away from the imaging device. Further, viewing the surrounding area of the object helps to determine the location of the object. In this embodiment, the server includes image recognition software.

A receiving device having a display is also in communication with the server of the system. The system provides an image of the defined area to the display of the receiving device and the system provides indicia on the image of the defined area indicating the location of the object in the defined area. Along with the image of the location of the object on the receiving device, a written description of the location of the object may also be sent to the receiving device.

Yet another embodiment is directed to a method for tracking an object in a defined area. In this method, the object is identified with a computer server by comparing at least a partial three-dimensional image of the object taken by an imaging device to a three-dimensional model stored in a database. The method includes determining the location of the object from the image of the object and the area surrounding the object provided by the imaging device. Also, the location of the object can be determined by analysing the location of the imaging device, the field of view of the imaging device, and the distance the object is located away from the imaging device.

The location of the object is stored in memory or a database that is in communication with the server. Additional information about the object, including product and installation information can be stored in the database and associated with the object.

Further, information concerning the location of the object may be sent to a receiving computer device having a display that is in communication with the server. The image of the object and the area surrounding the object may be sent to the receiving computer device to help identify the location of the object. Additional information concerning the object can be sent to the receiving device as well. The method also may include marking the location of the object on the video image of the object and the area surrounding the object that is sent to the receiving computer device. A description of the location of the object can be sent to the receiving device.

In one embodiment of the method of tracking the object, the method further includes monitoring the location of the object by comparing at least a partial three-dimensional image of the object taken by the imaging device to a three-dimensional model stored in the database and determining the location of the object from the video image of the object and the area surrounding the object from the imaging device. The monitoring can be done continuously, on request, or at any desired interval of time. If during the method it is determined that the object has moved to a new location, this new location of the object is tracked and stored in the database.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 is a schematic diagram of a tracking system including tracking technology and imaging devices used to identify an object and determine the location of the object.

FIG. 2 depicts an example of a wireframe or node structure of a tire.

FIG. 3 is a schematic diagram of an object located on a shelf down an aisle in an area of interest, such as a warehouse or facility.

FIG. 4 is a flowchart of a method for searching for an object and finding a location of the object using the tracking system.

FIG. 5 depicts a screen shot of the tracking system on a display of a receiving computer device, such as a mobile imaging device.

FIG. 6 is a schematic diagram of a tracking system including imaging devices used to identify an object and determine the location of the object.

FIG. 7 is a flowchart of a method for locating and monitoring the location of objects in an area of interest using the tracking system depicted in FIG. 6.

FIG. 8 is a flowchart of a method for locating and displaying information of an object using the tracking system.

FIG. 9 is a flowchart of a method for installing parts or objects during a manufacturing process using the tracking system.

### DETAILED DESCRIPTION

In one embodiment, a tracking system utilizes location tracking technology coupled with an imaging device to provide an accurate real-time visual display of a location of an object, item, part, product, or the like. This may be accomplished by tracking a location of an object in relation to a particular reader, whether that is a Global Positioning Satellite (“GPS”), Radio Frequency Identification (“RFID”) Reader, Near Field Communicator, or the like. Further, the tracking system realizes the location of the imaging device and the location of the object in relation to the imaging device. Combining information received from the tracking technology with information obtained by the imaging device allows the tracking system to determine a coordinate location of the object and allows any object located within the field of view of the imaging device to be visually displayed on a screen. The system may also store and provide information associated with objects or a group of objects. This tracking system may be setup as a permanent installation with a control hub, or may be mobile.

It has also been contemplated that the tracking system can be used to track a single object or part through a manufacturing process of a larger product, such as an aircraft, furniture, automobiles, or the like. More specifically, the tracking system is able to pinpoint the location of an object from the point it is produced and entered into the system, through its installation on a larger product.

In another embodiment, the tracking system utilizes a Z-depth or depth-sensing camera or other type of three-dimensional imaging device to provide an accurate visual display (real time video feed or still image) of a location of an object, item, part, product, or the like. It has also been contemplated that a stereoscopic camera alone or in combination with a Z-depth (depth-sensing) camera may be used. Using a Z-depth camera and a stereoscopic camera together may increase the accuracy of identifying an object because more information concerning the identity and location of the object will be gathered using both types of cameras simultaneously. In this embodiment, the tracking system identifies the object by comparing node and/or wireframe images of an object sent from the Z-depth camera to a database of computer generated (“CG”) models of objects. Once the object is identified, the location of the object also can be monitored using information sent from the Z-depth camera as discussed more below.

By way of example only, the tracking system allows users to search for objects, including objects that may be lost or misplaced in an area of interest, such as a facility, warehouse, store, storage facility, building, or any other type of area. By using an imaging device, a tracking tag, and/or a database stored with CG models of objects to be tracked, the tracking system may utilize information collected from the imaging device along with tracking information provided by the tracking tag to identify the object, establish the location of the object within a defined or undefined area, and monitor the location/movement of the object. The imaging device may recognize and delineate “zones” of the area of interest, and an alphabetical/numerical coordinate can be created using a series of zones with multiple sub-quadrants to pinpoint and record the location of a part or assembly that has attached a tracking device. These coordinates also may be sent to a receiving computer device to help locate the object.

Referring now to the drawings, wherein like reference numerals denote like or corresponding parts throughout the drawings and, more particularly to FIGS. 1-9, there are shown various embodiments of an image recognition tracking system 10. More specifically, as shown in FIG. 1, the image recognition tracking system 10 includes at least one server 20 that is in communication with at least one imaging device 22 and a database 24. In one embodiment, the imaging device 22 is a Z-depth camera or depth-sensing camera. Also, a stereoscopic camera may be used as the imaging device or both the stereoscopic camera and Z-depth camera may be used in combination. In general, a Z-depth cameracan determine the distance an object is away from the camera, which allows the Z-depth cameras to gather node information of an object. More information can be gathered by using the Z-depth camera and the stereoscopic camera together, compared to gathering information from only one of these cameras. The information gathered from both cameras can be used to build a wire or node structure of the object. The node information of the object may be used to create an image of a three-dimensional space. Any type of imaging device capable of capturing images in three dimensions may be compatible with the tracking system. More specifically, a LIDAR (Laser Imaging Detection and Ranging) camera could be used in other embodiments. A LIDAR camera is capable of capturing images in three dimensions using multiple lasers scanning the field of view resulting is an image having several thousand nodes or data points as is known in the art. In yet another embodiment, a camera similar to a Microsoft Kinect camera, which is an example of a stereoscopic camera, may be used as the imaging device. The stereoscopic camera uses two cameras set at a specific distance apart and angled to the same focal point, similar to a 3-D film camera. The stereoscopic camera also utilizes an infrared camera to visualize depth, as well as map the surrounding area, which allows the camera to take images of objects as nodes or wireframes, which is similar to how CG models of objects are prepared.

Also, the tracking system may include a tracking tag 26, such as an RFID tag, attached to a part or object 28 to be tracked. A tracking reader, such as an RFID reader 30, can monitor the location of the tracking tag. Memory associated with the server 20 or a separate database 24 can be used to store information relating to the objects being tracked by the system. A back-end computer or control panel 32 may also be in communication with the server and/or database to access, create, and edit information stored on the server and/or database. In certain embodiments, the back-end computer may function as a central hub for operating the tracking system.

The server 20, back-end computer 32, or a separate module (not shown) in communication with the server may analyse information received from the tracking reader 32 to determine the location of the object. The server may also send information concerning the location of the object and descriptive information of the object to a receiving computer device 34 via a network 36. The network may be any local area network, wide area network, cellular network, cloud based network or the Internet. The receiving computer device 34 may be any type of computer having a display, including stand-alone desktop computers, mobile devices, smart phones, tablets, laptops, or the like. If the receiving computer device 34 includes an imaging device, then the receiving computer device can be used to capture images of objects to be sent to the server for analysis.

Also, the server 20 may be any computer. By way of example, and not by way of limitation, the server may include 32 GB GDDR5 Ram, capable of approximately 7 teraflops of data processing, with a minimum 12-core processor. In other embodiments, multiple single core processors may be connected to achieve lower energy consumption and higher processing power than a single 12-core processor. Still further, a cloud-based server with appropriate capabilities could function as the server 20.

The server 20, back-end computer 32, or the separate module associated with the server, will be required to include image recognition software to identify objects in the field of view of the imaging devices 22 or receiving computer device 34 having an imaging device. The server, back-end computer, or separate modules associated with the tracking system can be programmed to utilize the image recognition software and the imaging devices together. The tracking system can identify viewed objects by comparing images of objects taken by the imaging device to stored CG models of objects. The configuration of each imaging device 22 and the location of the imaging devices may be unique to the facility utilizing the tracking system and the configurations and locations will be known and inputted into the tracking system. Furthermore, in one embodiment, the location of the tracking readers 30 will also be known and inputted into the tracking system. Proprietary software may also be used with the tracking system and designed specifically for each facility using the tracking system. By way of example only, and not by way of limitation, the proprietary software may use algorithms that identify objects to be located, search for the location of the object, provide descriptive information (including assembly information) of the object, monitor the location of all or some objects, send alerts when an object is moved or if a defect is detected, and display search results in a desired format.

In one embodiment, the database 24 may store CG models for each part or object to be tracked by the tracking system 10. The CG models stored in the database generally are created in a wireframe or node structure, similar to the wireframe structure of an object shown in FIG. 2. Using software, such as Autodesk, AutoCAD, Maya, Hudini, Rhino, CATIA and the like, CG models can be stored in a digital environment. The tracking system may use the CG models stored in the database as a reference. The image captured by the imaging device 22 can be converted into a wireframe or node structure by the imaging device or by the server 20. In one embodiment, the server 20 of the tracking system instructs one or more imaging devices to scan the field of view in order to determine whether any viewed object is stored in the CG database. This is done by comparing the wireframe or node format of the stored CG model to the wireframe or node representation of objects being viewed by the imaging device. If a certain desired percentage of nodes of the object visible to the imaging device match the nodes of a stored CG model, the tracking system can identify the viewed object as being associated with the stored CG model.

Also, it is possible that the server 20 can reference the CG model database and determine if the part or object being viewed by the imaging device 22 has any defects. This may be helpful to prevent a faulty part from being installed into the larger product. If only a certain percentage of nodes of the object visible to the imaging device match the nodes of a stored CG model for the object, then the tracking system can alert the user that the part may be defective. This percentage or percentage range will depend on the structure of the object.

The database 24 may also store information concerning the objects or parts. For example, any information concerning the object may be stored, including a description of the object, shipping information, assembly information concerning the object and the like. This information will be associated or linked with the CG model of the object or part. The tracking system can send and display this information to a requesting user.

In one embodiment, as shown in FIG. 1, the tracking tag 26, such as an RFID tag is attached to each part or object to be tracked. The tracking tag may also be attached to a box or other type of container storing objects. It has been contemplated that other tracking technology such as GPS or NFC devices could be used in place of or in combination with the RFID tag. The tracking tag may be programmed with any information required for the part or object being tracked, such as, part number, part name, product description, weight, color, instructions for installing the part, or the like. Also, the information associated with the part or object may be stored in the database 24 and linked to the tracking tag by a product number or other identification. By using tracking technology, such as RFID, GPS, or NFC, the general location of an object can be determined, and the location information gathered allows the server to identify the general location of the object on a map or describe the object's location in other terms. In general, the tracking reader 30 sends location information to the server 20 of the tracking system 10. This location information of the object may be relative to the reader itself, and the server is able to identify the location of the object in the area of interest since the location of the tracking reader is inputted into the tracking system.

The tracking tag technology provides an approximate location to the server 20 of the tracking system 10. This information can be used to identify the imaging device 22 in the best location to scan and view the area the object is located, so that the tracking system can identify the object and show its exact location on a display of the receiving computer device 34. With the location information supplied by the tracking technology, the tracking system can identify a general location of the object, within approximately five feet of its exact location. The distance of the approximate location may differ depending on the technology being used. In one embodiment, the RFID reader 30 or other tracking technology can be in a centralized location of the facility or area of interest. The RFID reader is then capable of determining the location of a RFID tag 26 in relation to the RFID reader itself. As an example, the reader can determine if a RFID tag is twenty meters due east of the location of the reader. The reader sends this location information to the server of the tracking system, which has the location of the imaging devices and the location of the reader stored in memory. The system cross-references the location information of the object sent from the RFID reader 30 with the locations of the imaging devices 22, and is able to identify an imaging device with a field of view of the approximate location of the object. In another embodiment, if the user is tracking an object using a mobile imaging device, the GPS coordinates of the mobile imaging device can be compared to that of the RFID reader, in order to provide directions from the mobile device to the approximate location of the object. An image taken from the image device closest to the approximate location of the object can also be sent to the mobile imaging device of the user. This allows the user to stream a live feed from the depth sensing camera to their mobile device. In this embodiment, the mobile device does not need a depth-sensor installed to track the object.

However, in another embodiment, a mobile device may include a built in depth-sensing camera to scan the area and track an object. As an example only, a handheld three-dimensional mapping device may be used in place of or in combination with the imaging devices 22. It has been contemplated that the handheld three-dimensional mapping device could be used to scan certain areas that are not in the field of view of an imaging device 22. The handheld three-dimensional mapping device may include an integrated camera, integrated depth-sensing, and an integrated motion tracking camera. In this embodiment, the handheld three-dimensional mapping device can send a live feed or still images back to the server, and provide node and wireframe information of objects and the surrounding area. This information can then be used to locate or identify objects in the field of view of the handheld three-dimensional mapping device.

To identify the one or more objects, a marking or indicia 40 may be displayed on a real time image or schematic image of the area of interest (facility) to highlight or identify the location of the object as shown in FIG. 3. Also, in combination with the indicia on the map or separately, the location of the object may be described, such as describing the coordinates of a map, zone, area, shelf, aisle, floor, etc. As an example, the tracking system may display that the searched for object is located on shelf 1C of aisle 12 in a facility as shown in box 42 of FIG. 3.

Any number of imaging devices 22 can be located around the area of interest, and it is preferred that enough imaging devices are installed to cover and view the entire area of interest, such as the entire floor of a warehouse. Also, the location and identity of each imaging device 22 installed around the area of interest is known to the server 20 and can be plotted on a map. Further, the system is programmed with the scope of the field of view of each imaging device 22, which allows the tracking system 10 to utilize a specific imaging device with a field of view covering the general location of a part established by the tracking tag. By using Z-depth cameras, stereoscopic cameras, or other three-dimensional imaging devices, additional information can be collected from the imaging devices; including the distance objects are located away from the imaging device.

As an example only, and not by way of limitation, one imaging device faces north, is mounted 12 ft in the air, and is mounted facing downward at a 45 degree angle. The camera continually shoots a single line out of the camera for a “center line”. This center-line runs to the floor of the area and is a first reference point for the imaging device. In this example, the distance from the imaging device to the floor along the center-line is 20 ft. With this information, the system may create a right angle triangle for its field of view. This triangle is 12 ft on its back end and 20 ft on the hypotenuse, and using the Pythagorean Theorem, the system knows that the distance along the floor from the imaging device to the first reference point is 15 ft. This provides an exact distance the first reference point is from the camera along the floor. In this example, the software communicates with the imaging device to create a similar triangle every 1/1000 of a degree to the right and left of the center line until it fills the entire field of view for the imaging device. The system will perform these steps every 1/1000 degree above and below the center line. The number of iterations needed to create a node and/or wireframe structure will depend on the lens/camera of the imaging device and the desired definition of the three-dimensional image created by the system. This effectively maps the depth of an entire space.

Based on the information that the imaging devices 22 provide to the system of the viewed area, the system can reconstruct the area, and objects within the area, in a node and/or wireframe structure. As described above, node and/or wireframe information collected by the imaging devices is delivered to the tracking system to create at least a partial three-dimensional image of the object. Using image recognition software, the tracking system is able to compare the node/wireframe information of the object from the imaging device to CG models in the database 24 in order to identify the object. The CG models in the database 24 are three-dimensional images of the entire object, and the system compares the partial three-dimensional object acquired from the imaging device to all sides, views, or angles of the compete three-dimensional image of the CG model. The system will recognize if the partial three-dimensional object acquired from the imaging device is a match to any part of the complete three-dimensional image of the CG model.

One embodiment of a method of using the tracking system 10 is described with reference to FIG. 4. At step 50, a user may query a part or object 28 to find its location or view general information about the object 28 using the back-end computer 32 or the receiving computer device 34, such as a mobile device. Based on the identification of the object provided by the user, the tracking system 10 can communicate with the tracking reader 30 to search for the tracking tag 26 associated with the object 28 and determine the general location of the object at step 52. By way of example only, the server may constantly be scrubbing the RFID reader for the location of all tracked objects within the range of the tracking reader 30. The tracking reader or readers can be tuned from 1 foot to 500 feet based on the needs of the facility. Based on the location information provided from the tracking reader 30, the tracking system 10 can display the location or provide a description of the location of the object 28 on the receiving computer device 34 at step 54.

At step 56, the system determines a more accurate location of the object 28. In this step, the server 20 can reference a CG model of the object 28 in the associated database 24 based on the identification of the part provided by the user. The server may then communicate with the imaging device 22 that is scanning or has a field of view covering the general location of the tracking tag 26 attached to the object 28. Designated imaging devices(s) 22 transmit images to the server 20 to identify the requested object 28 by comparing images in the field of view of the image device to the stored CG image of the object obtained from the database 24. Using image recognition software installed on the server 20 or on a module associated with the server, the server can identify the exact location of the object 28 in the area of interest. Further, using information gathered by the imaging device 22, such as a Z-depth camera, the distance to the object from the imaging device can be established, and the viewing location and viewing angle of the imaging device will be known by the system to help pinpoint the location of the object 28.

Once the tracking system 10 pinpoints the location of the object 28 by identifying the object with the imaging device 22, the object can be displayed or highlight on a display of the receiving computer device 34 at step 58 of FIG. 4. In one embodiment, a live video feed from the image device can be displayed on the receiving computer and the object 28 may be highlighted with an indicia 40 as shown in FIG. 3. It has also been contemplated that a still image or schematic representation of the area of interest can be displayed with the object being highlighted on the still image or schematic representation of the area. Depending on the size and set-up of the area of interest, the system can display other information about the location of the object to the user, such as the room or building number, isle number, or shelf number to help identify the location of the object. In this way, the system can describe the exact location of the object to the user along with providing a still image or live video feed of the area of interest in order to help locate the part. This is an improvement over using tracking technology to locate the object, which can only provide an approximate location of the object.

Furthermore, the tracking system 10 may include filtering options available to allow a user to view a description or other information of the object 28, and display one or multiple objects on a screen. Such filtering options may include viewing all objects in the facility, viewing one or more objects by part number or installation number, and viewing objects in a certain area of the facility. The system may display the filtering options 44 on a display 46 of the receiving computer device 34 as shown in FIG. 5, and the filtering options may be fully customized to the needs of a particular user.

It has also been contemplated that the tracking system 10 may not require the use of the tracking tag 26. This embodiment of a tracking system 50 shown in FIG. 6, is similar to the system shown in FIG. 1, except there is no tracking tag 26 attached to the object 28 or tracking reader 30. This embodiment shown in FIG. 6 includes the server 20 in communication with imaging devices 22, the database 24, back-end computer 32, and receiving computer device 34 via a network 36. By way of example, the use of a Z-depth camera, stereoscopic camera, or other type of three-dimensional imaging device 22, along with image recognition software may enable the system to identify the location of a part in the field of view of the Z-depth camera, since the location of the camera is known and the angle and distance of the part from the Z-depth camera can be determined by the system. In this embodiment, there would be a pre-programmed database 24 of CG models consisting of all parts and objects a facility wishes to track. All information about the part or object would be associated with the CG model instead of a tracking tag in this embodiment. Further, the server may correct any distortion of the image captured by the imaging device 22 because the type of camera and lens being used would be known to the server, thus allowing the server to compare the non-distorted CG model to the non-distorted image from the camera. The system determines if there is a match, and if there is a match, the system identifies the object as the name or description given to the CG model.

In one embodiment, the tracking system 50 tracks parts or objects 28 through a facility during a manufacturing process of a larger product, such as an aircraft, where the parts or objects are installed to create the larger product. It has also been contemplated that the tracking system can be used to monitor whether the parts have been correctly installed during manufacture of the larger product. This may be achieved by using the receiving computer device 34, including technology that provides a heads up display (“HUD”) on any screen or glass, or similar devices, coupled with a Z-depth, stereoscopic, or similar camera capable of viewing and providing images in three-dimensions. As an example only, the HUD device may also include an integrated camera, integrated depth-sensing, or an integrated motion tracking camera for use with the system and the imaging devices 22. In one embodiment, the HUD device would use the integrated camera to recognize a part or object from a predetermined CG database. Information associated with the part would be linked to the CG model and include information on how the part is to be installed into the larger product, along with information on the progress of the manufacturing of the larger product. This information can be displayed to the user on the HUD device.

By way of example only, the tracking system 50 can be used when manufacturing an aircraft, however, it should be understood that the tracking system can be adopted to the construction of any larger product so long as the final product has been constructed in the CG realm beforehand, including all of the smaller parts that are used to complete manufacturing of the larger product.

In one embodiment, the receiving computer device 34, such as a mobile imaging device, can take an image of the part or object 28. The server 20 can receive the image of the part 28 from the receiving computer device 34 or any imaging device 22, then recognize the part by comparing the captured image to the CG database. After identifying the part, the server 20 can display information about the part to the user on the receiving computer device 34, including information on installing the part. Since the final product has been digitally modelled, the server is able to recognize the area that surrounds where the part is to be installed. An image of the surrounding area can be taken with the receiving computer device 34 (mobile imaging device), and the system can recognize the surrounding area of where the part is to be installed and visually show the user the exact rotation and angle that the part is to be installed. After installation is complete, an image of the installed part can be taken with the receiving computer device 34 (mobile imaging device or HUD device), and due to the fact that the entire aircraft was created using CG models, the server can reference the CG model and based on the angle/rotation of the part and its surroundings, determine whether or not the part is installed correctly. If the part is not installed correctly, an alert can appear on the display of the receiving computer device 34 and possibly give solutions to fix the problem before progressing any further in manufacturing of the aircraft. If the part is installed correctly, the server can update the system that the part was installed. The system can do so for every part ensuring that each part was installed correctly. Such a tracking system may result in major savings for the company that would normally spend additional time and money correcting installation of the one part that was incorrectly installed.

An example of a method of using the tracking system 50 is described with reference to FIGS. 6-9. In this embodiment, the tracking system uses information provided by the imaging device 22, such as a Z-depth camera, to locate parts or objects 28 in an area of interest. As shown in FIG. 7, at step 90 the server 20, imaging devices 22, and database 24 become active on start-up. During the start-up procedure, software installed on the server, or a separate module associated with the server, verifies that all components of the system (server, database, imaging devices, etc.) are active and in communication with one another directly or over the network 36. If a component is not active or is not in communication with the server 20, the server or module sends an appropriate alert to pre-approved personnel via email, text message, voice message, or dedicated website. Appropriate measures can then be taken to perform maintenance on the non-responding component or connection.

After initializing the tracking system 50, the server 20 uses algorithms based on close proximity pixel edge relation, (contrast, color difference/similarity, etc.) to identify like pixels that make up edges or sides of objects that are visible within the field of view of the imaging device 22 or devices at step 92 of FIG. 7. These algorithms can be adapted to the specific imaging devices as well. As described above, the server can relate nodes and wireframes of objects stored in the database to the nodes and wireframes being received from the imaging devices to recognize any object stored in the database. Based on the results from the algorithms, the server identifies where and if the edges of the pixels relate to form a certain edge or side of an object. At each point or pixel, the server creates a grab point or node. The server then connects the nodes to build an outline of the object within the field of view of the imaging device. This is done for each object. Comparing the node layout received from the imaging device(s), the server 20 references the database 24 and determines at step 94 if the object is already represented in the database, which is composed of pre-determined CG models built with nodes, wireframes, outlines, etc.

If the server 20 does not find matching outlines (wireframe or node structure) of the object 28 in the stored CG models of the database 24, the server 20 sends an alert to pre-approved personnel. The alert notifies the personnel that the object 28 at a certain location is not referenced in the database at step 96. The server continues to scan the area of interest until a tracked object is identified. When the server 20 identifies an outline from the database that matches the wireframe image of the object taken by the imaging device(s), the server determines and stores the location of the object in the database at step 98. In this step, it is the location of the object 28 within the field of view of the imaging device 22 that is being stored in the database 24. This location is stored until the object moves, in which case the imaging device(s) 22 identifies the movement and stores the next resting location of the object 28. If the object 28 is scanned by the receiving computer device 34 (mobile imaging device), the location of the object can be attached to the current location of the mobile device based on the GPS location of the mobile imaging device.

Once a location of the object 28 is established by the server 20, the server begins to continually track or monitor the location of the object at step 100. If it is determined by the server 20 that the object leaves its “safe zone” (pre-determined areas where the object should be from manufacturing through installation) for five minutes (or any other designated amount of time), the server communicates with the imaging device(s) 22 in the area that the object was last detected and records the live video feed from about thirty seconds (or any other designated amount of time) before the object was last detected in the safe zone until predetermined personnel stops the recording. The server sends out alerts to the predetermined personnel about a lost object at step 104.

When the server 20 finds an outline (wireframe) from the database 24 that matches the outline (wireframe) of the image of the object 28 taken by the imaging device(s) 22, the server may display these outlines or other indicia on top of the live video stream generated by the imaging device on a display of the receiving computer device 34. The live video stream and overlaid image of the object 28 may also be sent to any web browser, application, mobile web browser, or the like. Also, a still image taken from the imaging device 22 may be used, and in other embodiments, a schematic drawing or other representation of the area of interest may be displayed. An example of a screen shot taken from the receiving computer device 34 is shown in FIG. 5. As the system continues to monitor the location of the identified objects, the outline of the objects or other indicia may move in real-time on the display of the receiving computer device 34. In addition to outlining the object in real time over the layout of the facility or area of interest, an interactive information box 42 can also be displayed as shown in FIG. 5. The interactive information box may display to the user any information deemed necessary by the facility. This information can include anything, for example, color, weight, product description, quantity, related objects, installation information, and the like.

In one embodiment, the server 20 may display filtering options 4, such as searching for and viewing one particular object, searching for and viewing a group of particular objects, searching for and viewing objects in a specific area, searching for and viewing objects needed for a particular project or build, searching for and viewing the next object required for a particular project or build, searching for and viewing all objects in an area of interest, and the like. An example of filtering options 44 is also shown in FIG. 5. The tracking system may also be customized so that any filtering option may be included to assist the users. The server displays the tracking results based on the filter options selected by the user.

Also, the tracking system 50 may monitor parts or objects 28 throughout the entire manufacturing process of a larger product, such as an aircraft. The steps of this method are shown in FIG. 8. The server 20 can reference the database 24 not only for identifying objects 28 and parts, but also for referencing the full-scale final CG model of the product being manufactured. Utilizing the same process from tracking system 50 as described above, the system is able to use the imaging devices 22 (a mobile imaging device or HUD device) to recognize, outline, and determine the location of the parts or objects 28 to a user at step 120. At step 122, the location of the objects 28 can be displayed in real-time or the location of the objects can be updated on request or at specific intervals. The server 20 displays filter options for the objects or parts (one particular object, groups or objects, etc.) and the server displays the tracking results based on the selected filter options. Users may have the option to view the live or static video image, information relating to the part or object including location information, and installation information from a computer at a fixed location, or a mobile device with imaging capabilities.

A user may also select an information box of the particular object or objects for display. This action causes a custom window or box 42 to open displaying the information of a selected object as shown in FIG. 5. This information is predetermined based on what the facility would like to have at its disposal. Based on a pre-programmed installation guide provided by the facility, the system is able to identify the order in which the parts are to be installed to complete manufacturing of a larger product or a portion of a larger product. The system may display what part number is currently being installed by the user. The server can also provide the user with information or instructions on installing the part.

On the display shown in FIG. 5, the user may select an “install” icon 60. After selecting this icon, the user has the option to identify a part, view progress of the project, or install the part. A “location history” icon 62 can also be selected which will display the location history of the part or object. The tracking system tracks every stored location of the part or object as it moves through the facility since it was discovered or entered into the system. A “remove part” icon 64 is also shown in FIG. 5, and selecting this icon will remove the select part or object from the system so that the system will no longer track the location of the selected part. Finally, FIG. 5 shows an “add new part” icon 66 that will allow the user to enter a new part into the database 24 of the system. The tracking system will then begin to track the location of the new part. It has also been contemplated that other features can be made available to the user as desired.

At step 124 of FIG. 8, the user may select “view progress” of the manufacturing of the product or view information of a known part or object. Due to the ability of the system to track each object or part being installed for the project, the system can monitor which parts have been installed, are currently being installed, and the order the parts are to be installed. The system can display this information within an install window (not shown) on the display. In one embodiment, the system can provide an animation to the user showing a real time CG model of the product being built and its current state of progress. The system allows the user to view information or install the part.

At step 126 of FIG. 8, the user may identify an unknown part or view information about a part by selecting the identify part icon (not shown) on the display of the receiving computer device 34. The user may then capture an image of the part using a camera connected or associated with the receiving computer device 34 or mobile imaging device. Using the same process as identified above, the server 20 identifies nodes, outlines the nodes, and determines the identity of the unknown part by comparing the outline (node/wireframe structure) to the CG model database. The system can then display the object 28 with its installation information to the user at step 126.

If the server 20 does not recognize the part or object 28, the server may display an alert box to the user stating the part is not recognized at step 130. The server or designated personnel can then determine whether the part does not belong in the manufacturing process or is simply defective, by referencing the imaged part and comparing it to its CG counterpart already stored in the database 24. The server 20 can also direct the user to the next part or object that is to be installed and provide its location in the safe area at step 132.

The user may use the tracking system 50 to help install parts during the manufacturing process of a larger product as described in the chart shown in FIG. 9. To start the installation process, a part is selected using the receiving computer device 34 or mobile imaging device, at step 140. To select the part, the user may identify the part using the receiving computer device 34 or may take an image of a part to be installed and allow the tracking system 50 to identify the part based on image recognition as described above. The system may recognize the selected or imaged part and display its installation information, including the part's installation number and order in the installation process. If the selected or imaged part is not the next in line to be installed, the system displays an alert notifying the user that the part cannot be installed at this time at step 142. The server may then identify the part that is next in line to be installed and directs the user to the location of that part in step 144.

If the part is next in line to be installed, the tracking system 50 opens and displays the same full-scale real time CG model of the product (not shown) being built as used in the “view progress” menu discussed above. On the display of the full-scale real time model, the system may highlight the imaged or selected part in the exact location where the part is to be installed on the final product in step 150. The server may cause a dialog box to be displayed describing where the part is to be installed and instructions for installing the part. The server may also allow the user to zoom, rotate, and manipulate the CG model to assist the user in finding the installation location of the part. When in front of the installation location of the part, the system may prompt the user to take an image using the mobile imaging device of the installation location of the part at step 152. Utilizing the same process as described above and using the real time model being built as a reference, the tracking system is able to recognize the parts surrounding the part to be installed at the designated location. Comparing identified installed parts to the full-scale CG model, the system may determine if the surrounding installed parts have been installed correctly at step 154.

If the surrounding parts have not been installed correctly, the server may send an alert to predetermined personnel that a particular part or parts have not been installed correctly, and that the image of the surrounding parts does not match the previously built full scale CG model of the product being built. The system instructs the designated user to remove the incorrectly installed part and verify that it is the correct part for this location, and verify that it has no defects. If the system does not recognize the identified part or the part is recognized to have a defect by comparing the node/wireframe structure of the imaged part to the node/wireframe structures of the CG models in the database, the user is instructed to set the part aside. The system may also send out alerts to predetermined personnel of an unidentified or defective part including the current location of the part. The system may then direct the user to the proper part and highlight its location within the facility so the user can easily find the proper part for installation. If the surrounding parts have not been installed correctly, but the system recognizes the parts to be the correct parts with no defects, the server can instruct the user to correctly re-install the parts.

If the surrounding parts have been installed correctly, the tracking system 50 may cause an instruction box to be displayed to the user, describing exactly how the next part in the installation process is to be installed at step 156 of FIG. 9. A video of the part and all of it components being installed virtually may be displayed to the user. After installation of the part, the system may request that the user take an image of the installed part to verify that the part was installed correctly at step 158. This verification process is done the same way as referencing the surrounding area of the parts. The system compares how the part was installed on the virtual model, comparing those nodes and wireframes to the object being viewed with the imaging device.

The system 50 may then verify that the part was installed correctly. If the part was installed correctly, the system digitally installs the part on the “view progress” model and updates the progress of the manufacturing process for the product. The system may then identify the next part to be installed based on the pre-installation guide at step 160. The server continues to track the installation of all parts, through the same installation process until the installation phase of the product is complete and all parts have been installed and verified. Depending on the facility and the workflow, the tracking system 50 may be used to repeat the production of the same product or may be updated and installed with information for completing manufacturing of a different product.

In yet another embodiment, the tracking systems 10 or 50 can be used to identify certain indicia affixed to an object, container, or area storing parts or objects. By way of example only, a QR code may be affixed to the object or container that could be read by the imaging devices 22. By reading the QR code, the system can track a box of small parts through a facility. Other types of indica affixed to the object or container could be a specific color and/or shapes on the container, such as a yellow triangle or blue square. A barcode could be affixed to the container if it is large enough to be read by the imaging devices 22. Further, relatively large color letters, numbers, or symbols could also be affixed to the object or container so that the imaging device 22 could identify the object/container and its contents. In one embodiment, ultraviolet ink could form the indicia. The ultraviolet ink may be readily identifiable by the system. The system may recognize any type of indicia, color, or symbol. The database 24 would store the indicia, color, or symbol associated with any object or container of objects. This will allow the system to reference information concerning the object or container of objects and allow the system to track the objects. In these embodiments, any type of high-resolution camera could be used as the imaging device to identify any indicia, color, or symbol.

One of ordinary skill in the art will appreciate that not all tracking systems will have all these components and may have other components in addition to, or in lieu of, those components mentioned here. Furthermore, while these components are viewed and described separately, various components may be integrated into a single unit in some embodiments.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A system for tracking an object in a defined area, comprising:
a tracking tag attached to the object;
a tracking reader that monitors the location of the tracking tag, the tracking reader is located in the defined area;
an imaging device installed in the defined area, and the imaging device having a field of view;
a server in communication with the tracking reader and the imaging device, wherein the tracking reader provides the server with information concerning the location of the object in relation to the tracking reader, and the imaging device provides an image of the object to the server; and
a receiving device in communication with the server, and the receiving device having a display;
wherein the server provides an image of the defined area to the display of the receiving device and the server identifies the location of the object on the image of the defined area.

2. The system of claim 1, further comprising a database storing a computer generated model of the object.

3. The system of claim 2, wherein the server includes image recognition software.

4. The system of claim 1, wherein the tracking tag is an active RFID tag.

5. The system of claim 1, wherein the tracking tag is a GPS locator.

6. The system of claim 1, wherein the imaging device provides a partial three-dimensional image of the object.

7. The system of claim 6, wherein the imaging device is a Z-depth camera and the Z-depth camera provides at least a partial three-dimensional image of the object to the server.

8. A system for tracking an object in a defined area, comprising:
an imaging device installed in the defined area, and the imaging device providing at least a partial three-dimensional image of the object and an image of the defined area surrounding the object;
a database storing a computer generated three-dimensional model of the object;
a server in communication with the imaging device and the database, and the server compares the three-dimensional image of the object from the imaging device to the three-dimensional model of the object stored in the database to identify the object; and
a receiving device having a display in communication with the server;
wherein the server provides an image of the defined area to the display of the receiving device and the server identifies the location of the object on the image of the defined area.

9. The system of claim 8, wherein the server includes image recognition software.

10. The system of claim 8, further comprising a tracking tag attached to the object and a tracking reader that monitors the location of the tracking tag, and the server is in communication with the tracking reader, wherein the tracking reader provides the server with information concerning the location of the object in relation to the tracking reader.

11. The system of claim 8, wherein the imaging device is a Z-depth camera and the Z-depth camera provides a node structure of the object and an image of the defined area surrounding the object to the server.

12. A method for tracking an object in a defined area, comprising:
identifying the object with a computer server by comparing at least a partial three-dimensional image of the object taken by an imaging device to a three-dimensional model stored in a database;
determining the location of the object from the image of the object area surrounding the object taken by the imaging device;
storing the location of the object in a database in communication with the server; and
sending the location of the object to a receiving computer device having a display in communication with the server.

13. The method of claim 12, further comprising sending the image of the object and the area surrounding the object to the receiving computer device.

14. The method of claim 13, further comprising marking the location of the object on the image of the object and the area surrounding the object that is sent to the receiving computer device.

15. The method of claim 12, wherein sending the location of the object to the receiving device includes a description of the location of the object.

16. The method of claim 12, further comprising monitoring the location of the object and determining a new location of the object.

17. The method of claim 16, further comprising storing the new location of the object in the database.

18. The method of claim 16, wherein the location of the object is monitored continuously.

19. The method of claim 12, further comprising storing information associated with the object in the database and sending the information associated with the object to the receiving computer device.

20. The method of claim 19, wherein the information associated with the object includes information concerning installation of the object for a manufacturing process.
